(19) United States
(12) Patent Application Publication
(10) Pub. No.: US 2003/0201362 A1
(43) Pub. Date: Oct. 30, 2003

(54) Helicarplane

(76) Inventor: Fushun Yang, Schaumburg, IL (US)

Correspondence Address: FUSHUN YANG, 1225 CHAMPLAINE CT., SCHAUMBURG, IL, 60193, US

(21) Appl. No.: 10/131,930

(22) Filed: Apr. 25, 2002

(51) Int. Cl. B64C 37/02; B64D 5/00

(52) U.S. Cl. 244/2

(57) ABSTRACT

This invention provides another basic important means of transportation after motor vehicle, airplane, helicopter: helicarplane. Helicarplane can run on ground roads, take off and land in fixed-wing style or in helicopter style; can fly quickly and economically in fixed-wing airplane style.

Agility, adaptability, convenience, and timesaving are helicarplane's advantages. Helicarplane enlarges the active room for human beings with significant effect of economy and society.

This invention is an helicarplane suitable of passenger/cargo transportation, and it can also work like a motor vehicle moving on ground roads.

### BACKGROUND OF THIS INVENTION

Regarding the existing fixed-wing airplane and helicopter, there is a security problem-if its one engine fails, they are easy to be in trouble. The fixed-wing planes can't liftoff and land vertically as helicopter, and the speed, economical efficiency of helicopter is lower than the airplane, and the motor vehicle is troubled by the crowded ground, time wasting.

### SUMMARY OF THE INVENTION

Aimed at above shortages of the existing transportation, this paper provides “helicarplane”, which possesses the advantages and functions of airplane, helicopter and motor vehicle

The purpose of this invention is realized in following way:

Following is the technical principle of this invention Install a group of rotor (call it “top rotor”, dual-impellers or multi-impellers) above the fuselage to revolve and generate lift force Simultaneously, install another group of rotor (call it “bottom rotor”, dual-impellers, multi-impellers or disk-shaped architecture) under the fuselage to revolve in a direction opposed to the above one's to generate lift force and torsion to offset or balance the clockwise torsion of fuselage caused by the counter-clockwise revolving of top rotor. So, properly choosing suitable power (engines) for every rotor, arranging the area, size, relative location and corresponding angle of top rotor and bottom rotor to fuselage, the helicarplane can liftoff and descend vertically like a helicopter, and meet the demand of control for flight in air by operating every aerodynamic control surface (tail/front wings and tail rudder) and the drag direction rudder, which is under the fuselage to cooperate with the bottom rotor. This helicarplane is also composed of a special architecture that is when the helicarplane in flight its tail wing can change it's position from a status of retracted close to and along the fuselage to a status of extending the tail wing to their left and/or right rear direction then becoming a horizontal tail wing, thus the helicarplane can change its flying style from helicopter to fixed-wing airplane. It also comprises a front canard wing (called “front wing”), the external part of front wing besides the head of helicarplane also can be completely extended from retracted status to become front wing.

### BRIEF DESCRIPTION OF THE DRAWINGS

FIG. 1: front view (FV) of one of samples.

FIG. 2: side-looking/oblique view

FIG. 3 side-looking-cutaway view

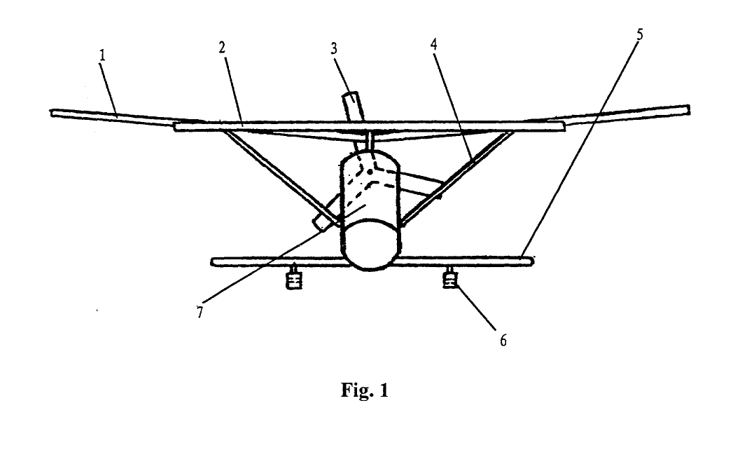

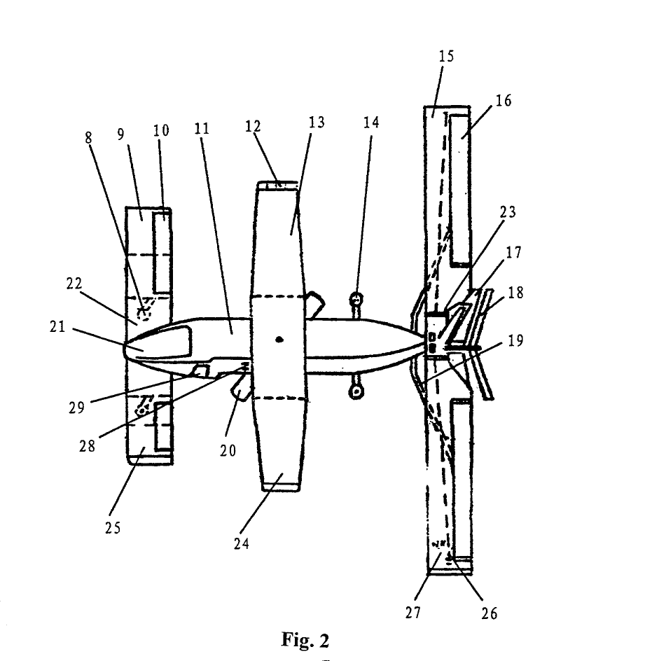

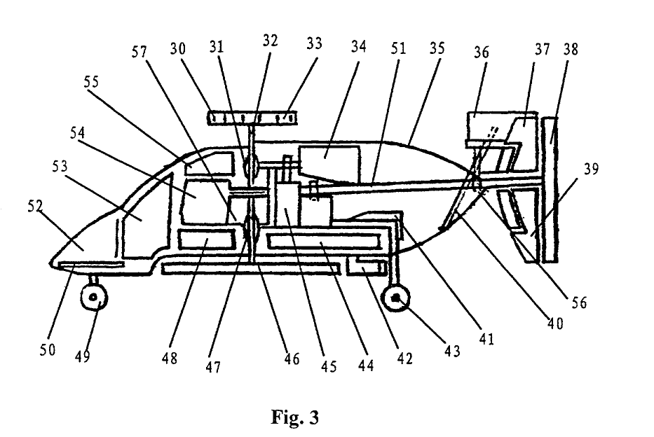

In FIG. 1, “1” is the up-warped horizontal tail; “2” is the top rotor; “3” is the push propeller (with 3 impellers) on the tail; “4” is the supporting pole of horizontal tail wing; “5” is the front wing; “6” is one of the front wheels; “7” is cockpit (pilot room, and equipment chamber); In FIG. 2, “8” is one of the front wheel; “9” is the front wing; “10” is the aileron of front wing; “11” is the front fuselage; “12” is the wingtip turbine on the end of top rotor; “14” is one of the rear wheel (in un-retractable style); “15” is the horizontal tail wing, which can be retracted forwards and closed to fuselage perpendicularly and locked on the fuselage; “16” is the aileron of horizontal tail wing; “17” is the upper area of tail rudder; “18” is push propeller with 3 impellers on the tail of fuselage; “19” is the supporting pole of tail wing, the supporting point is based on the rear fuselage; “20” is bottom rotor; “21” is cockpit; “22” is the fixed part of front wing; “23” is the pole for supporting the tail wing; “24” is the joint part where the outside half part of top rotor turns up and fold; “25” is the joint of upwards folded parts of front wing (the front wing separating into two parts). The said upwards folded parts is away from the centerline of fuselage by about 1 meter; the joint is the fixed part of front wing and nearly inclined to the cockpit when the front wing is folded; “26” is pulling-rope; “27” is “locking ring”; “28” is the hole which locking bolt insert into; “29” is door of cockpit.; In FIG. 3, “30” is top rotor; “31” is the reducer of top rotor; “32” is the driving shaft of the top rotor; “33” is the wingtip turbine for lift-adding installed on the ends of top rotor; “34” is the engine mainly used to drive the top rotor and the tail rotor; “35” is the rear half of fuselage; “36” is the horizontal tail wing, which is upwards warped from the centerline of fuselage toward to outside tail wing end in a little bit degree; “37” Is the upper one of tail direction rudder; “38” is the tail rotor (push propeller); “39” Is lower one of tail direction rudder; “40” is the mechanism of ground running system; “42” is the drag-caused direction rudder to play the role cooperatively with the bottom rotor. This each of two rudders is installed each one at left and right side under fuselage and along the fuselage; “43” is one of the rear wheels; “44” is fuel tank; “45” is a set of combined clutch; “46” is the bottom rotor; “47” is the reducer of bottom rotor; “48” is fuel tank or luggage case; “49” is one of front wheel; “50” is front wing; “51” is the driving shaft of tail rotor; “52” is cockpit; “53” is a door; “54” is the engine mainly to drive the bottom rotor and ground running system, it can be used to drive the top rotor and tail rotor by passing through the combined clutch and linkage etc; “55” is the bearing linkage of driving shaft of tail rotor, this shaft of tail rotor can get power from both two engines separately or jointly; “56” is one of the supporting frame of driving shaft; “57” is one part of weight and force-supporting the whole platform in the middle of fuselage.

### DETAILED, THE GIVEN ENFORCEMENT SAMPLE OF THIS INVENTION IS

The invention (helicarplane) is the 3-wing-surface configuration: front wing, top rotor and horizontal tail wing. Front wing is a canard one on the left and right sides of helicarplane's head. The span of front wing is 4 m when extended. Under the left and right wings, there is a front wheel with steering function, respectively. Front wheel track is about 2 m. The width of 3 wing-surfaces are basically the same, about 0.70 m-0.80 m, and the level angle of front wing is 00.

Top rotor is a group of rotors above the center of gravity of fuselage. We can make a disk-shaped configuration on the center area (about 2 m in diameter) of top rotor. Install a wingtip turbine on the edge of top rotor in order to increase the lift force. And when the helicarplane is driving on the roads, fold the outside half (out from 1 meter in radium of top rotor) of top rotor above the cockpit, inwards, then downwards and put it flatly. Lock the top rotor along with the fuselage and fix it above the center of top rotor. During flying by fixed-wing style, the top rotor can be extended and Locked perpendicular to the fuselage to be as a fixed lifting surface.

The span of tail is about 8 meter, and it can be warped upwards from the center respectively to the left and right end of tail wing, the warp-angle is about 3°-5°. It also can be folded inwards/downwards and respectively retracted from the left and right sides to the fuselage, thus the horizontal tail wing perpendicularly retracted and locked to the fuselage from level status. Now, this is the style of helicarplance during driving on the ground roads.

During driving on the ground roads, 2 outside parts (1 m in radium away from the centerline of fuselage) of front wing are also folded upward first, then inwards and downwards.

There are 2 engines installed inside the fuselage, one is to drive the top rotor. The engine can be installed under the shaft of top rotor or in the rear space of fuselage. In this enforcement sample, this engine locates on the position behind the shaft of top rotor. The engine is also used to drive the push style tail rotor which behind the tail wing and tail direction rudder. The tail rotor is a 3-impellers construction, the diameter is about 1.60 m-1.80 m, Propeller with 3-impellers is quieter than 2-impellers one, less noise.

Another engine is used to drive the bottom rotor, which is installed under the fuselage with the same centerline as top rotor. The bottom rotor has different architecture: duel-impellers or multi-impellers, even special shaped disk, it should be as wide as possible, 2 meter in diameter, its geometrical deflection should be advantage for anti-inclining of fuselage. The bottom rotor can be locked along with the fuselage. For the helicarplane with more than 2 seats, the diameter of its bottom rotor can be chosen to 3.5 meter or much longer. The engine used to drive the bottom rotor also can drive the ground running system (it combines clutch, transmission shaft, reducer, wheel, vibration hanging damper and brake equipment, etc) Through operation of the combined clutch, reducer (1 level or 2 level) and driving shaft of coupling, this engine also used to drive the tail rotor (separately or cooperatively with another engine to increase the power, and improve the flying speed), or to drive the top rotor. It is very useful in occasion of emergency in air to realize safely landing or secure flying.

All these possible locations of installation are allowed in principle, it depends on the size and actual occupied space. In this paper, the given enforcement is a single seat prototype of helicarplane.

At least the capability of the fuel tank is about 20 gallons (US style) composed of one or several tanks. It is better to install the tank near the gravity center of the shaft of top and bottom rotor located. Arranging the location of other equipment and luggage case also obeys this rule.

On the centerline of fuselage, in the limiting range of tail and near the tail rotor, installing 2 rudders (the upper rudder is above a shaft, the lower rudder is beneath the shaft, and this shaft goes at the space between the upper and lower rudders and brings power to tail rotor).

On a suitable two side low place of rear fuselage respectively to install two fixed structured supporting points, Based on the 2 supporting points, respectively install 1 support pole with a certain curved lower end. And still on the 2 points, the pole can turn around following the pre-shaped surface or angle. The upper end of the pole is connected with the supporting points on the down surface of tail wing. The pilot in cockpit uses a dual-direction revolving architecture with the same principle as eggbeaten-machine, The pilot actuates a special handle revolving, by doing so to revolve this mechanism in two directions (clockwise or anti-clockwise) to control two pulling ropes (with high strength), respectively. And the pulling ropes respectively, independently pass through the fuselage backwards connecting with 2 ends of tail wing. When the pulling ropes are forced, a driving force occurred and force the tail wing retracting to fuselage or extending to the horizontal tail wing position, which depend on the different revolving direction of said special handle. Therefore the tail wing can be controlled on different needed position, the helicarplane can fly in air, or drive on the ground roads. The strength and thickness of the pulling rope depends on the size, weight of helicarplane. In this enforcement sample, about 1 cm diameter pulled rope is enough.

When tail wing is retracting or extending, their tracks are controlled by the supporting pole's moving limitation for security the moving tail wing does not crush with top rotor in flight.

There is one convex with two round holes on the face down surface of both left and right tail wings. It can be called “locking rings”. When the tail wing retracts to the fuselage, the convex will contact the special part of fuselage and conduct a “locking bolt” inserting into the round holes then lock the tail wing, and with the role of supporting pole together the tail wing is in controlled without shaking freely.

On the upper surface of fuselage, the air inlet of motor is designed.

The 2 front wheels are steering ones, and 2 rear wheels are for driving with power. The wheel track of rear wheel is as same as the front wheels-about 2 meters. It is in the limitation of the ground road width.

The maximum width of cabin is about 80 cm (not included the support point of supporting pole). Commonly, the height of cabin is decided by the comfortable requirements of pilot. The flying instrument is various, and there is also some equipment used for ground control and operation. Certainly, the height of the chamber should be as low as possible.

In this enforcement example, the whole system includes shafts of 2 groups of rotor and reducers are supported by a forced stand in the cabin. Varying from the configuration of engine, the driving shaft of engine installed in front of the center shaft of top and bottom rotors will pass through special gears if needed, if there is no need, it will pass between the two ends of the top rotor and bottom rotor's shafts, connect with and drive the bottom rotor and its reducer. Passing by the combined clutch and coupling, this driving shaft will pass force to top rotor, ground running system, even tail rotor to meet the control requirement.

The ground system mentioned above is installed on the rear space inside fuselage.

Along with the stream way of bottom rotor, install a rudder on 2 bottom sides of fuselage respectively, to help adjust the torsion of the 2 groups of rotor (top rotor and bottom rotor), and keep the flight direction and position of fuselage. Rear wheel is on the backside of this rudder.

According to the principle and configuration of the invention, due to the various sizes of different rotors, the power of top rotor and bottom rotor, the power of driving engine of rotor are different. It is also possible to operate with graded power, and use fuselage and top/bottom rotor alternatively.

The specialized relative position among the 3 items will lead to a torsion changing of the fuselage, by controlling this torsion, the fuselage of helicarplane can be kept in the required direction and position.

In this enforcement example, it is possible to do not assemble the impeller-operation, angle-shifting equipment of top/bottom propellers, instead of revolving the impeller in fixed position and angle Therefore, the construction is simplified with reduced weight and higher reliability. In more detail, during revolving, keeping fixed angle (relative to the front wing and tail) of 2 groups of rotor (including the centerline) the fuselage will move lightly without operation of tail in air. At this moment, changing the angle of aileron aerodynamic control surface of front wing and tail wing in determined area, the helicarplane can keep the suspended-flying status or rise and descend vertically, or move forwards/backwards and leftwards/rightwards slowly to hover (locating).

The mid area of top propeller can be wider, toward to 2 ends with a gradually narrow in width. The bigger the lift force of the top rotor gains, the shorter the length of the top rotor, and the length of the whole helicarplane can be. The top impeller can be designed with little angle of elevation and it can be turned around geometrically in certain degree from the center of shaft to 2 ends.

On the centerline of fuselage, in the width limitation of tail wing, a rudder is installed just ahead of the tail rotor. This rudder is composed of 2 parts of linkage: upper one and lower one. A driving shaft passes from the mid space and passes driving force to the tail rotor backwards. The tail propeller is a push propeller with 1.70 m-1.80 m in diameter.

Regarding the ground security, we can install a thin mesh net covering the bottom rotor beyond the limitation of occupied space of bottom rotor. It should set a rule or obey certain rule. When the helicarplane operates a landing to ground vertically, a warning signal (light or sound) should be released by itself to warn the people on the ground so that they can take care of the descent of the helicarplane.

When liftoff in helicopter style, firstly to start the top rotor the bottom rotor, then the helicarplane can rise, ascending to the required height, extend the front wing and tail wing then disconnect the bottom rotor and transfer the driving force of bottom rotor to tail rotor. As soon as the tail rotor reaches a safe operation speed, and the force generated by it can keep the helicarplane in flight, the driving power to the top rotor can be stopped. Then this driving force to top rotor can transfer to the tail rotor completely in 100%. Thus there are 2 options of operating engines: running 2 engines jointly to drive the tail rotor to gain higher flight speed or only running one of the two engines to drive the tail rotor. With the force transmission by combined clutch and linkage, the driving force generated by 2 engines can drive the same shaft of tail rotor individually or jointly. The shaft of tail rotor is supported by several stands fixed in supporting points, and it is connected with the push propeller in the tail of fuselage.

Sure, the helicarplane can extend its front wing and tail wing on the ground, then drive the tail rotor to take off and land like a fixed-wing airplane.

Following is the construction of front wing and its extending and retracting procedure. Use the construction similar to the horizontal tail wing. Pilot can operate the specialized functional handle, to actuate the pulling rope in a direction to extend the front wing when the front wing is fully extended, pilot manages an insertion of the push-pole (inside the front wing) to the connecting notch by hands. On this condition, the push-pole changes its function to be the level beam of wing construction and the procedure of extending front wing is finished. When retracting, firstly pull back the push pole (in level direction), and control the handle to give the negative force relative to the push force, the pulling rope at the joint of the front wing is forced to arch, recover to the close status gradually.

During flying, helicarplane can descend as helicopters by changing its flying style from fixed-wing airplane. At first, the engines will disconnect the driving power to tail rotor, the helicarplane begins slide flight, then the top rotor and bottom rotor will start revolving at the same time to operate each aerodynamic surfaces and rudders. When arriving above the landing destination, the helicarplance does a landing vertically with the help of tail rotor for locating. Besides big and small airports, the helicarplane can rise and land on ground road, yard and roof vertically. Due to large quantity of helicarplane flying on different heights above cities, it needs the remark navigation and guidance equipment in the ground. The automatic driving, navigation aid, locating and communication equipment with high technology also should be chosen and in use.

Under two sides of fuselage behind the bottom rotor, facing the stream way of bottom rotor, install drag-caused direction rudders (each under the body of 2 sides) to assistant steering, The direction rudder of tail can help steer by turning around and facing the stream of bottom rotor.

The two front wheels are for steering, and the two back ones are for driving (on each rear wheel on a side of the two rear sides of fuselage) with hydraulic brake equipment and vibration damper.

High away from ground by certain height, bottom rotor and tail rotor can hold good stream field and ground effect by keeping the suitable relative position with fuselage and 3-wing-surfaces. The power of engine for bottom rotor motor is less than the power of top one, for example 85 and 118-125 horsepower, respectively. The RPM of top rotor is above 500.

According to the principle and configuration of this invention, the helicarplane is suitable for different passengers or cargo weight, from single seat to 8, even more seats.

Commonly, the diameter of bottom rotor is shorter than that of top rotor. The bottom rotor can be locked along with the longitudinal way of fuselage. When the diameter of bottom rotor is about 2 meter, it is no problem to drive on the road. The track of front and rear wheels also is about 2 meter. Concerning the weight of whole helicarplane, it is designed that the front and rear wheel can be un-folded to save the weight of folding equipment.

Between 2 groups of rotor, it is the fuselage of helicarplane. The diameter and square size of rotor is different from common ones, such as coaxial helicopter. Compared to the common plane, this of the 2 motors individually to improve the security and reliability. The two groups of rotor can not only balance the torsion to keep the flying way, but also separately adjust the power of itself to form the torsion to turn around the helicarplane during keeping the needed lift force.

Installed on the same centerline, the shafts of top and bottom propeller are connected with reducer gears by forced platform and supporter frame, to becoming an entire construction.

There are different options of air instrument. Try to use the light material to manufacture the construction, fuselage and equipment of this helicarplane. The weight of this helicarplane is 1,100-1,300 pounds without payload. When the top rotor is running, the length of it is about 5.8 m, the length will be a little bit shorter if one part of top rotor is folder during running on the ground.

On the ground, the height of this helicarplane may lower than 2.20 m. The total weight of it is about 1,400-1,700 pounds including one-man plus luggage (200 pound) and fuel (130-200 pound).

Based on new principle and structure, this invention (helicarplane) provides a new means of transportation, its key point is by using two groups of rotor revolving in opposed direction, this helicarplane reach a capability of lift-off, descent vertically. The helicarplane also comprises front wing and tail wing, which suitable for the requirements of flight and can be folded properly to meet the requirements while it runs on ground roads. In order to meet above requirements and enhance the safety level, two engines are installed inside the helicarplane, each one of the two engines not only respectively drives the top rotor and bottom rotor, but also can respectively drives tail rotor and conventional ground motor running system (this system in clued transmission reducer brake wheel and clutch), furthermore there are many different model of conventional clutch available, which can be used for transferring both the two engine's driving power to a certain one of working devises, for example, tail rotor.

The helicarplane essentially comprises various conventional systems or devices used on airplane and car, but these systems or devices are not the point of this invention, so this specification of helicarplane did not give more special description on them, because they are conventional.

We can use less-weight belt-power-transfer device to instead of certain shaft-gear-structure, but they are also conventional. One more example, a certain control program and action model is needed between power (engine) and working device (such as rotor) and transmission for making a certain working device (rotor) on work or not-work condition.

The special effects of this invention is: helicarplane can run on ground roads, take-off and landing in fixed-wing style at big or smaller airports, can rise and descend in 10×10 m² ground space in helicopter style. While flying in air, it can fly fast and economically as fixed-wing airplane.

This invention provides a new means of transportation which posses the advantages and functions of fixed-wing airplanes helicopter and car. Its agility adaptability, convenience and timesaving, enlarge the active room for human beings with significant effect of economy and society. The helicarplane is a basic important production as car ships airplane.

What I claim is:

1. A helicarplane comprises two groups of rotors, one group of rotors installed at the bottom of fuselage, and another group of rotor at the top above fuselage, Rotors spin in opposed directions; The difference is each one of the two rotors is driven by a engine respectively; There is a wingtip turbine on the ends of the rotor, Center area of Top rotor is extra wide (but still within the width of ground roads), enable the diameter of two rotors as short as possible, meanwhile generates enough lifting force and easy to meet these constrained demands of ground roads width when the helicarplane runs on ground roads and these demands of flying and control-operative characteristics when the helicarplane flies in air.

2. The said Helicarplane of claim 1. The difference is it is comprised of horizontal tail wing and front wing; by using a mechanism which uses the principle of egg-beater machine to generate a revolving force in two directions and a special actuating-handle, the pulling-rope supporting pole with a role of restraint on limitation and position of tail wing when retracting and extending the tail wing. The locking-rings on left and right of fuselage, The locking bolt inside the fuselage, horizontal tail wing can be pulled tightly, then turns obliquely and descends perpendicularly close to and locked along the both sides of fuselage, the front wing can be executed by a retracting and extending action, by using a similar mechanism of the horizontal tail wing, which includes force-generating mechanism, special actuating-handle, pulling-rope, push pole. Thus whenever the helicarplane is flying in air, liftoff and descends vertically or running on ground roads, the horizontal tail wing and front wing both can through above mechanism change status from one to another, such as retracting or extending.

3. The said helicarplane of claim 1. The difference is: the helicarplane comprises of engines, reducers, a combination of clutch, ground running system, top rotor, tail rotor, and bottom rotor, each of two engines the helicarplane installs inside fuselage can be assembled in various positions with above said reducer (one level or multi-level), a combination of clutch and use the engines driving force respectively or alternatively to actuate the whole or one or a few of top rotor, tail rotor and the ground running system.

4. The said helicarplane of claim 1, the difference is: the helicarplane comprises drag-caused direction rudder, which is installed under rear fuselage, one rudder on both left and right sides of fuselage thus that each rudder can reduce its size and length facing stream or cooperate with bottom rotor to playing the role of direction control.
